(19) United States
(12) Patent Application Publication
(10) Pub. No.: US 2026/0049032 A1
(43) Pub. Date: Feb. 19, 2026

(54) SILICA FUME AS WATER REDUCER, CORRESPONDING ALKALI-ACTIVATED MATERIALS AND PREPARATION METHODS THEREOF

(71) Applicant: Guangdong University of Technology, Guangzhou City (CN)

(72) Inventors: Weiping ZHU, Guangzhou City (CN); Jiali HE, Guangzhou City (CN); Xianpeng WU, Guangzhou City (CN)

(21) Appl. No.: 19/287,961

(22) Filed: Aug. 1, 2025

Related U.S. Application Data
(63) Continuation of application No. PCT/CN2025/092350, filed on Apr. 30, 2025.

(30) Foreign Application Priority Data
Aug. 13, 2024 (CN) 202411102565.0

(51) Int. Cl. C04B 18/14; C04B 18/08; C04B 22/06; C04B 28/26; C04B 103/30

(52) U.S. Cl. CPC C04B 18/146; C04B 18/08; C04B 18/141; C04B 22/062; C04B 28/26; C04B 2103/302

(57) ABSTRACT

A use of silica fume (SF) as water reducer for alkali-activated materials (AAMs), applicable to both fly ash-based low-calcium AAM and slag-based high-calcium AAM, is provided; additionally, the fly ash-based low-calcium AAM and slag-based high-calcium AAM with their preparation methods are also provided. The fly ash-based low-calcium AAM with the SF as the water reducer is prepared from following materials: SF, fly ash and alkaline solution; and the slag-based high-calcium AAM with the SF as the water reducer is prepared from the following materials: SF, slag, and the alkaline solution.

### CROSS-REFERENCE TO RELATED APPLICATIONS

This application is a continuation of International Patent Application No. PCT/CN2025/092350, filed on Apr. 30, 2025 and claims priority of Chinese Patent Application No. 202411102565.0, filed on Aug. 13, 2024. The contents of International Patent Application No. PCT/CN2025/092350 and Chinese Patent Application No. 202411102565.0 are hereby incorporated by reference.

### TECHNICAL FIELD

The disclosure relates to the field of novel environmentally friendly and low-carbon building materials, and relates to a new use of silica fume (SF) as a water reducer, a fly ash-based low-calcium alkali-activated material (AAM) and a slag-based high-calcium AAM prepared according to the new use, and preparation methods of the corresponding AAMs.

### BACKGROUND

AAM refers to inorganic polymers composed of Si—O—Al—O bonds formed by the polymerization of Si—Al-rich precursors under the activation of an alkaline solution. AAM has shown excellent mechanical properties, low shrinkage and good durability in corrosive environments. Compared with ordinary Portland cement (OPC), whose production involves high CO₂ emissions due to the calcination of raw materials (limestone and clay), the production of AAM may reduce CO₂ emissions by 70 percent (%). Moreover, if AAM is used instead of OPC, energy consumption may be saved by 60%. Therefore, AAM is considered as a sustainable alternative cementitious material to OPC. AAM may be divided into high-calcium AAM represented by alkali activated slag (AAS) and low-calcium AAM represented by alkali activated fly ash (AAF) according to the calcium contents in precursors. In high-calcium AAM, it generates calcium alumina silicate hydrate (C-A-S-H) gel with Tobermorite structures, while in low calcium AAM it forms sodium alumina silicate hydrate (N-A-S-H) or geopolymer gel with a crosslinked and disordered zeolite structures. Both AAMs may reduce the environmental impact caused by OPC production and achieve industrial waste recycling.

Like OPC, the liquid-solid ratio greatly affects the mechanical performance of AAM. According to research, the mechanical properties of AAM may be significantly improved using lower liquid-to-solid ratios. However, low liquid-solid ratios also reduce flowability/workability of the fresh material, making it difficult to cast and affecting its engineering application. Therefore, to ensure excellent mechanical properties and workability, the use of water reducer in concrete preparation is critical; as they may reduce concrete liquid-to-solid ratios while maintain the workability. At present, the development and research of water reducer are mainly aimed at OPC and its related concrete.

The conventional water reducers used in OPC system have limited effects on improving AAM flowability/workability, and even lead to a decrease in AAM mechanical properties. This is mainly because most water reducers are unstable in high alkaline environment (potential of hydrogen (pH)>13) thus losing their water reducing functions. Moreover, it appears that different precursor materials also affect the capacities of water reducers. For example, polycarboxylates have shown better improvements in low-calcium AAM (AAF) compared to naphthalene-based water reducers. In high-calcium AAM (AAS), polycarboxylates did not improve workability much. Overall, conventional water reducers used in OPC system perform poorly in different AAM systems.

As an industrial waste, SF is a by-product resulted from the production of metallic silicon and ferrosilicon. SF consists of fine spherical particles and a large amount of glassy silica. According to statistics, the annual output of SF in the world is 1 million tons (t). To promote the recycling of this waste, SF is mainly used as a supplementary cementitious material with OPC to prepare concrete. Adding SF into concrete often increases water demand. However, in our research experiment, it is unexpectedly found that adding SF may reduce water/liquid demand in AAM.

China patent CN105819719A discloses an enhanced geopolymer and a preparation method thereof. Raw materials such as phosphate and/or polyphosphate, metakaolin, fly ash, water glass, alkaline compounds, silicon dioxide and water are blended according to their parts by weight, and the raw materials are ground and mixed into uniform slurry, and the slurry is injected into a mold and cured at room temperature or low temperature (20-80 Celsius degrees (° C.)) to obtain a product. The geopolymer product obtained by the formula and the preparation method disclosed by the disclosure is resistant to high temperature and chemicals, and has excellent mechanical properties, and the compressive strength reaches more than 150 Megapascal (MPa), thus meeting use requirements of building materials and high-temperature coatings.

CN116395998A discloses a three-dimension (3D)-printable AAM slurry, a product containing the AAM slurry, and a preparation method and application thereof, where the AAM slurry contains an aluminosilicate precursor; the alkali activator includes MOH, M₂O·nSiO₂ and H₂O, where M is an alkali metal; and a modifier.

U.S. Pat. No. 9,266,783 discloses solid tailored geopolymer precursor materials containing fly ash (59-91%), sodium hydroxide (11-15%), rice husk (0.8-11%) and optional sodium silicate (0-29%), however, the mechanical properties of the composition need to be improved.

US2009/0229493A1 discloses a highly compressible silica mortar, composing of 30-70 weight percentages (wt %) of silica, 40-70 wt % of blast furnace slag, and 15-35 wt % polycondensation regulators per 100 parts by weight of the silica dry mortar powder. The mortar is characterized by generating C-S-H, CAH, an amorphous geopolymeric matrix {Al₂O₃·mSiO₂·nM₂O·xH₂O (M=K, Na, Ca)} and zeolite. The high-strength silica mortar exhibits a compressive strength of more than 70.0 MPa after vibration forming and curing at 25-80° C. for 12-48 hours (h), and it may save energy by curing for 12-48 h before removal of form and aging for 28 days (d). However, the highly compressible silica mortar contains a lot of silicon dioxide, and the cost is very high.

U.S. Pat. No. 8,440,016B2 discloses a ground granulated blast furnace slag for sulfate-resistant cement, containing a mixture of ground granulated blast furnace slag with an alumina content of 12-17.5 mass % and gypsum with a high dissolution rate of 2-6 mass %, and the mixture may be used for concrete mortar.

US20130081557A1 discloses a system, a method and/or a composition of an environment-friendly composite building material. The method includes providing a mixture of pozzolanic material and/or kaolin clay and an activator solution to form an aluminosilicate cementitious material through the resulting geopolymerization process. The aluminosilicate material is in paste form. The method also includes processing the aluminosilicate material to convert it into the form of aluminosilicate material powder. The method further includes mixing the powdered aluminosilicate material with water to control the workability of the aluminosilicate material.

The above-mentioned slag-based high-calcium AAM and fly ash-based low-calcium AAM all have certain defects in mechanical properties and high content of silica, which leads to high costs and makes it impossible to truly realize the low-cost of concrete. SF is widely used in concrete industry as a supplementary cementitious material. However, there has been scarce research on using SF as a water reducer in AAM. Therefore, this disclosure employs SF as a water-reducing additive to explore its effect, applications and preparation methods when used in high-calcium AAM (represented by AAS) and low-calcium AAM (represented by AAF).

### SUMMARY

The purpose of the present disclosure is to provide a use of SF as water reducer and corresponding AAM preparation method to address the aforementioned issues.

The objectives of the disclosure may be achieved by the following technical schemes.

In the first aspect, the disclosure provides a use of SF as water reducer for a low-calcium AAM or a high-calcium AAM.

In an embodiment, the low-calcium AAM is a fly ash-based AAM, and/or the high-calcium AAM is a slag-based AAM.

In an embodiment, SF is used as a water reducer in fly ash-based low-calcium AAM and slag-based high-calcium AAM.

In an embodiment, SF is amorphous SiO₂, where the average particle size of the SF is about 0.1-0.3 micrometer (μm), and a specific surface area ranges from 15-30 square meters per gram (m²/g).

At room temperature, SF is insoluble in water but soluble in alkaline solution, and may react with hydrofluoric acid aqueous solution. A differential thermal analysis curve of the SF shows that when heated above 500 Celsius degrees (° C.), amorphous SiO₂ is transformed into crystalline SiO₂, and the crystalline SiO₂ is cristobalite and/or tridymite.

In the second aspect, the disclosure discloses a fly ash-based low-calcium AAM; the AAM is prepared from the following materials: water reducer, Class-F coal fly ash (referred to as fly ash), and an alkaline solution.

In an embodiment, the water reducer may be one of naphthalene, borax, sodium hexametaphosphate, polycarboxylic acid, silica sand and SF.

In an embodiment, the water reducer is SF, where SF is amorphous SiO₂, the average particle size of SF is about 0.1-0.3 μm, and the specific surface area is in the range of 15-30 m²/g.

At room temperature, SF is insoluble in water but soluble in alkaline solution, and may react with hydrofluoric acid aqueous solution. A differential thermal analysis curve of the SF shows that when heated above 500° C., amorphous SiO₂ is transformed into crystalline SiO₂, and the crystalline SiO₂ is cristobalite and/or tridymite.

In an embodiment, the alkaline solution includes a mixture of sodium silicate solution and sodium hydroxide solution.

In an embodiment, according to parts by mass, the water reducer is 0.01-12 parts, the precursor fly ash is 80-150 parts, the sodium silicate solution is 20-35 parts, and the sodium hydroxide solution is 8-15 parts.

In an embodiment, according to parts by mass, the water reducer is 0.5-8 parts, the precursor fly ash is 95-105 parts, the sodium silicate solution is 25-30 parts, and the sodium hydroxide solution is 9-12 parts.

In an embodiment, according to parts by mass, the water reducer is 0.5-6 parts, the precursor fly ash is 100 parts, the sodium silicate solution is 27.1 parts, and the sodium hydroxide solution is 10.9 parts.

In an embodiment, according to parts by mass, the water reducer is 2-5 parts, the precursor fly ash is 100 parts, the sodium silicate solution is 27.1 parts, and the sodium hydroxide solution is 10.9 parts.

In an embodiment, according to parts by mass, the water reducer is 3-4 parts, the precursor fly ash is 100 parts, the sodium silicate solution is 27.1 parts and the sodium hydroxide solution is 10.9 parts.

In an embodiment, the fly ash is the precursor material for preparing AAM, and the mass percentage of each oxide in the chemical composition of the fly ash is as follows: 54.17 percent (%) of SiO₂, 31.57% of Al₂O₃, 3.48% of Fe₂O₃, 2.98% of CaO, 1.90% of K₂O, 1.37% of TiO₂, 1.22% of MgO, and 3.31% of others. The fly ash has a particle size distribution as shown in FIG. 4.

In an embodiment, the sodium silicate solution is used to prepare an alkaline solution, and the chemical composition of the sodium silicate solution accounts for 27.3% of SiO₂, 8.54% of Na₂O and the modulus is 3.3. The sodium hydroxide solution is used for preparing an alkaline solution, the sodium hydroxide solution is a liquid with a concentration of 10-20 molality (M) prepared by sodium hydroxide solids with a purity of more than or equal to 96%. Optionally, the concentration is 14 M.

In an embodiment, the sodium hydroxide solution may be replaced by other alkali metal hydroxide salts with high solubility, such as potassium hydroxide.

In an embodiment, the flowability (flow diameter) of the fly ash-based low-calcium AAM is not less than 200 millimeter (mm), and the compressive strength of the fly ash-based low-calcium AAM may reach 58 Megapascal (MPa). The compressive strength of the fly ash-based low-calcium AAM may be further enhanced without reducing its flowability (workability).

In the third aspect, the disclosure discloses a method for preparing a fly ash-based low-calcium AAM, which includes the following steps:
(1) respectively weighing 0.01-12 parts of water reducer and 80-150 parts of fly ash (AAM precursor), and weighing the materials by using an electronic balance, where the weighing balance accuracy of the materials is +0.01 grams (g);
(2) mixing the weighed water reducer with fly ash, and putting the mixture into a blender to be evenly stirred;
(3) weighing the materials according to 20-35 parts of sodium silicate solution and 8-15 parts of 10-20 M sodium hydroxide solution, and weighing the materials by using an electronic balance, where the weighing balance accuracy of the materials is ±0.01 g; in the chemical composition of the sodium silicate solution, SiO₂ accounts for 27.3%, Na₂O accounts for 8.54%, and the modulus is 3.3;
(4) preparing an alkaline solution: mixing the sodium silicate solution and the 10-20 M sodium hydroxide solution in the step (3) and uniformly stirring; and
(5) pouring the alkaline solution prepared in the step (4) into the mixed fly ash and water reducer in the step (2), and using a blender to stir for 3 minutes (min) until a uniform paste appears.

In an embodiment, after the step (5), the method for preparing a fly ash-based low-calcium AAM also includes the following steps:
(6) using a flowability tester (referred to as jump table) to test the flowability of the pasty AAM stirred in the step (5) according to ASTM C230 cement mortar flowability measurement method; and
(7) selecting the optimal flowability dosage to prepare the AAM test block, and testing the compressive strength.

In an embodiment, the water reducer is SF, which consists of white spherical particles with purity>99%.

In an embodiment, the water reducer is 0.5-8 parts, the precursor fly ash is 95-105 parts, the sodium silicate solution is 25-30 parts, and the sodium hydroxide solution is 9-12 parts.

In an embodiment, the water reducer is 0.5-6 parts, the precursor fly ash is 100 parts, the sodium silicate solution is 27.1 parts and 10-20 M sodium hydroxide solution is 10.9 parts.

In an embodiment, the fly ash is the precursor material for preparing AAM, and the mass percentage of each oxide in the chemical composition of the fly ash is as follows: 54.17% of SiO₂, 31.57% of Al₂O₃, 3.48% of Fe₂O₃, 2.98% of CaO, 1.90% of K₂O, 1.37% of TiO₂, 1.22% of MgO, and 3.31% of others. The fly ash has a particle size distribution as shown in FIG. 4.

In an embodiment, the sodium silicate solution is used to prepare an alkaline solution, and the chemical composition of the sodium silicate solution accounts for 27.3% of SiO₂, 8.54% of Na₂O and the modulus is 3.3. The sodium hydroxide solution is used for preparing an alkaline solution, the sodium hydroxide solution is a liquid with a concentration of 10-20 M prepared by sodium hydroxide solid particles with a purity of more than or equal to 96%. Optionally, the concentration is 14 M.

In the fourth aspect, the disclosure seeks the protection for the use of SF as a water reducer for fly ash-based low-calcium AAM, and the fly ash in the fly ash-based AAM is Class-F fly ash.

In an embodiment, the fly ash-based low-calcium AAM is the fly ash-based low-calcium AAM in the second aspect of the disclosure.

In the fifth aspect, the disclosure provides a slag-based high-calcium AAM using SF as water reducer; the AAM is prepared from the following materials: water reducer, S95 ground granulated blast furnace slag (referred to as slag), and an alkaline solution.

In an embodiment, the water reducer is SF, the SF is amorphous SiO₂, the average particle size of the SF is about 0.1-0.3 μm, and the specific surface area is in the range of 15-30 m²/g.

At room temperature, SF is insoluble in water but soluble in alkaline solution, and may react with hydrofluoric acid aqueous solution. A differential thermal analysis curve of the SF shows that when heated above 500° C., amorphous SiO₂ is transformed into crystalline SiO₂, and the crystalline SiO₂ is cristobalite and/or tridymite.

In an embodiment, the alkaline solution includes a sodium silicate solution and a sodium hydroxide solution.

In an embodiment, according to parts by mass, the water reducer is 0.01-12 parts, slag is 80-150 parts, the sodium silicate solution is 8-20 parts, and the sodium hydroxide solution is 14-28 parts.

Optionally, according to parts by mass, the water reducer is 0.5-8 parts, slag is 95-105 parts, sodium silicate solution is 10-16 parts and sodium hydroxide solution is 16-22 parts.

More optionally, according to parts by mass, the water reducer is 0.5-6 parts, slag is 100 parts, sodium silicate solution is 14.6 parts and sodium hydroxide solution is 20.4 parts.

More optionally, according to parts by mass, the water reducer is 2-5 parts, slag is 100 parts, sodium silicate solution is 14.6 parts and sodium hydroxide solution is 20.4 parts.

More optionally, according to parts by mass, the water reducer is 3-4 parts, slag is 100 parts, sodium silicate solution is 14.6 parts and sodium hydroxide solution is 20.4 parts.

In an embodiment, slag is the precursor material for preparing the AAM, and the mass percentage of each oxide in the chemical composition of the slag is as follows: 40.43% of CaO, 30.46% of SiO₂, 15.81% of Al₂O₃, 9.42% of MgO, 0.281% of Fe₂O₃, 0.423% of K₂O, 0.673% of TiO₂, 0.52% of MnO, 0.499% of Na₂O, 1.16% of S, 0.0549% of SrO, 0.0467% of Cl, 0.0391% of ZrO₂, 0.0389% of BaO, 0.017% of P₂O₅, 0.0084% of V₂O₅, 0.0083% of Y₂O₃, 0.0069% of CeO₂, and 0.0012% of CuO.

In an embodiment, the sodium silicate solution is used to prepare an alkaline solution, and the chemical composition of the sodium silicate solution accounts for 27.3% of SiO₂, 8.54% of Na₂O and the modulus is 3.3. The sodium hydroxide solution is used for preparing an alkaline solution, and the sodium hydroxide solution is prepared by adopting sodium hydroxide solid particles with a purity of ≥96%, where 1.8 parts of sodium hydroxide particles and 18.6 parts of distilled water are used.

In an embodiment, the sodium hydroxide solution may be replaced by other alkali metal hydroxide salts with high solubility, such as potassium hydroxide.

In an embodiment, the flow diameter of the slag-based high calcium AAM is not less than 236 mm, and the compressive strength may reach 104.6 MPa, which may be further enhanced without reducing its flowability (workability).

In the sixth aspect, the disclosure discloses a method for preparing of slag-based high-calcium AAM using SF as a water reducer, including the following steps:
(1) respectively weighing 0.01-12 parts of water reducer and 80-150 parts of slag, and weighing the materials by using an electronic balance, where the weighing balance accuracy of the materials is ±0.01 g;
(2) mixing the weighed water reducer with slag, and putting the mixture into a blender to be evenly stirred;
(3) weighing the materials according to 8-20 parts of sodium silicate solution and 14-28 parts of sodium hydroxide solution, and weighing the materials by using an electronic balance, where the weighing balance accuracy of the materials is ±0.01 g; in the chemical composition of the sodium silicate solution, SiO₂ accounts for 27.3%, Na₂O accounts for 8.54%, and the modulus is 3.3;
(4) preparing an alkaline solution, mixing the sodium silicate solution and the sodium hydroxide solution in the step (3) and uniformly stirring; and
(5) pouring the alkaline solution prepared in step (4) into the slag and powdery water reducer mixed in the step (2), and using a blender to stir for 3 min until a uniform paste appears.

In an embodiment, after the step (5), the method for preparing of slag-based high-calcium AAM using SF as a water reducer also includes the following steps:
(6) using a cement flowability tester (referred to as jump table) to test the flowability of the paste AAM stirred in the step (5) according to ASTM C230 cement mortar flowability measurement method; and
(7) selecting the optimal flowability dosage to prepare the AAM test block, and testing the compressive strength.

In an embodiment, the water reducer is SF, which consists of white spherical particles with purity>99%.

In an embodiment, according to parts by mass, the water reducer is 0.01-12 parts, the slag is 80-150 parts, the sodium silicate solution is 8-20 parts, and the sodium hydroxide solution is 14-28 parts.

Optionally, water reducer is 0.5-8 parts, the slag is 95-105 parts, sodium silicate solution is 10-16 parts and sodium hydroxide solution is 16-22 parts.

More optionally, water reducer is 0.5-6 parts, the slag is 100 parts, sodium silicate solution is 14.6 parts and sodium hydroxide solution is 20.4 parts.

More optionally, water reducer is 2-5 parts, the slag is 100 parts, sodium silicate solution is 14.6 parts and sodium hydroxide solution is 20.4 parts.

More optionally, water reducer is 3-4 parts, the slag is 100 parts, sodium silicate solution is 14.6 parts and sodium hydroxide solution is 20.4 parts.

In an embodiment, the slag is the precursor material for preparing the AAM, and the mass percentage of each oxide in the chemical composition of slag is as follows: 40.43% of CaO, 30.46% of SiO₂, 15.81% of Al₂O₃, 9.42% of MgO, 0.281% of Fe₂O₃, 0.423% of K₂O, 0.673% of TiO₂, 0.52% of MnO, 0.499% of Na₂O, 1.16% of S, 0.0549% of SrO, 0.0467% of Cl, 0.0391% of ZrO₂, 0.0389% of BaO, 0.017% of P₂O₅, 0.0084% of V₂O₅, 0.0083% of Y₂O₃, 0.0069% of CeO₂, and 0.0012% of CuO. The slag has a particle size distribution as shown in FIG. 4 of the specification.

In an embodiment, the sodium silicate solution is used to prepare an alkaline solution, and the chemical composition of the sodium silicate solution accounts for 27.3% of SiO₂, 8.54% of Na₂O and the modulus is 3.3. The sodium hydroxide solution is used for preparing an alkaline solution, and the sodium hydroxide solution is prepared by adopting sodium hydroxide solid particles with a purity of ≥96%, where 1.8 parts of sodium hydroxide particles and 18.6 parts of distilled water are used.

In the seventh aspect, the disclosure discloses the use of SF as a water reducer for slag-based high calcium AAM, where the slag in the slag-based high calcium AAM is S95 ground granulated blast furnace slag.

In an embodiment, the slag-based high calcium AAM is the slag-based high calcium AAM in the fifth aspect of the disclosure.

The disclosure has the following beneficial effects.

SF has been found for the first time as a water reducer for fly ash-based low calcium AAM and slag-based high calcium AAM.

Compared with traditional water reducers (naphthalene, polycarboxylic acid, borax and sodium hexametaphosphate), SF shows greater improvements in increasing the flowability of fly ash-based AAM, and the flowability may be increased by 40.8%.

Compared with traditional water reducers (naphthalene, polycarboxylic acid, borax and sodium hexametaphosphate), SF shows greater improvements in increasing the mechanical properties of fly ash-based AAM, and the compressive strength may be increased by 17%.

Compared with traditional water reducers (naphthalene, polycarboxylic acid, borax and sodium hexametaphosphate), SF shows greater improvements in increasing the flowability of slag-based high calcium AAM, and the flowability may be increased by 30%.

Compared with traditional water reducers (naphthalene, polycarboxylic acid, borax and sodium hexametaphosphate), SF shows greater improvements in increasing the mechanical properties of slag-based high calcium AAM, and the compressive strength may be increased to 104 MPa.

### BRIEF DESCRIPTION OF THE DRAWINGS

The present disclosure will be further described with reference to the attached drawings.

FIG. 1 is a flow chart of preparation of the fly ash-based low-calcium AAM of the present disclosure.

FIG. 2 is a graph showing flowability test results of the fly ash-based low-calcium AAM of the present disclosure.

FIG. 3 is a graph showing test results of compressive strengths of the fly ash-based low-calcium AAM of the present disclosure.

FIG. 4 is a particle size distribution diagram of the fly ash of the present disclosure.

FIG. 5 is a flow chart of preparation of the slag-based high-calcium AAM of the present disclosure.

FIG. 6 is a graph showing flowability test results of the slag-based high-calcium AAM of the present disclosure.

FIG. 7 is a graph showing test results of compressive strengths of the slag-based high-calcium AAM of the present disclosure.

FIG. 8 is a particle size distribution diagram of the slag of the present disclosure.

### DETAILED DESCRIPTION OF THE EMBODIMENTS

In the following, the technical schemes in the embodiments of the disclosure will be described in details with the attached drawings. Obviously, the described embodiments are only a part of the embodiments of the present disclosure, not the whole embodiments. Based on the embodiments in the present disclosure, all other embodiments in the field without creative work belong to the scope of protection of the present disclosure.

In an embodiment, the SF is amorphous SiO₂, the average particle size of the SF is about 0.1-0.3 micrometer (μm), and the specific surface area ranges from 15-30 square meters per gram (m²/g).

At room temperature, the SF is insoluble in water but soluble in alkaline solution, and may react with hydrofluoric acid aqueous solution. The differential thermal analysis curve of the SF shows that when the temperature is higher than 500 Celsius degrees (° C.), amorphous SiO₂ is transformed into crystalline SiO₂, and the crystalline SiO₂ is cristobalite or tridymite.

The SF is amorphous SiO₂ with purity>99 percent (%).

The silica sand is inert SiO₂, with a purity of >99%.

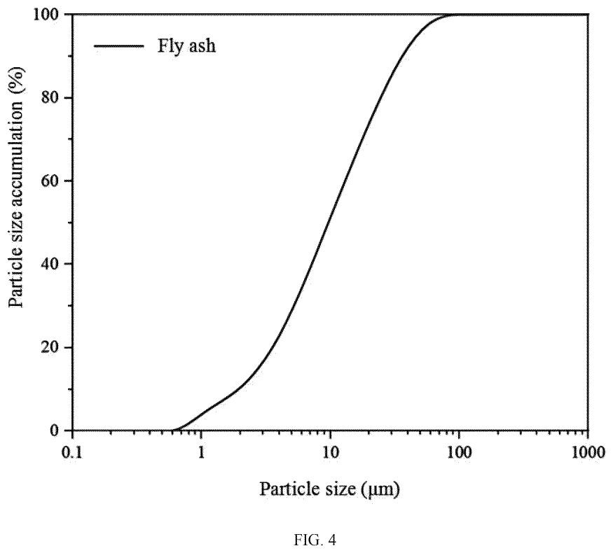

The fly ash-based low-calcium AAM is formulated according to the following parts by mass: (1) 100 parts of fly ash; (2) 27.1 parts of sodium silicate solution; (3) 10.9 parts of sodium hydroxide solution (14 molality (M)).

Where, the particle size distribution of the fly ash is shown in FIG. 4. The mass percentage of each oxide in the chemical composition of the fly ash is as follows: 54.17% of SiO₂, 31.57% of Al₂O₃, 3.48% of Fe₂O₃, 2.98% of CaO, 1.90% of K₂O, 1.37% of TiO₂, 1.22% of MgO, and 3.31% of others.

Where in the chemical composition of the sodium silicate solution, SiO₂ accounts for 27.3%, Na₂O accounts for 8.54%, and the modulus is 3.3.

Where the sodium hydroxide solution is a liquid with a concentration of 14 M prepared by sodium hydroxide solid particles with a purity≥96%.

### Control Group

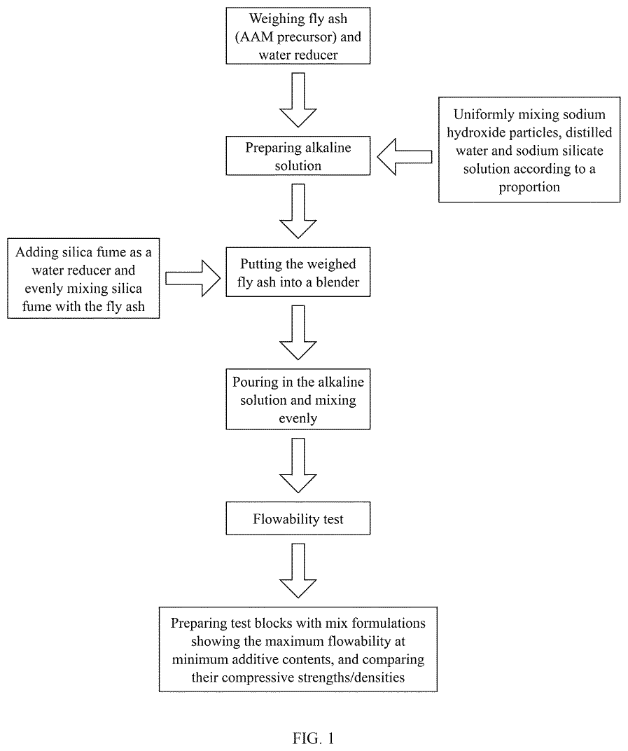

A method for preparing fly ash-based low-calcium AAM, as shown in FIG. 1, includes the following steps:
(1) weighing 100 parts of fly ash, and using an electronic balance to weigh the materials, where the weighing balance accuracy of the materials is ±0.01 grams (g);
(2) weighing 27.1 parts of sodium silicate solution and 10.9 parts of sodium hydroxide solution (14 M), and using the electronic balance to weigh the material, the weighing balance accuracy of the material is ±0.01 g;
(3) preparing an alkaline solution, mixing 27.1 parts of sodium silicate solution and 10.9 parts of sodium hydroxide solution (14 M) and uniformly stirring;
(4) pouring the alkaline solution prepared in the step (3) into the weighed fly ash in the step (1), and using a blender to stir for 3 minutes (min) until a uniform paste appears; and
(5) using a cement flowability tester (jump table) to test the flowability of the pasty AAM stirred in the step (4) according to ASTM C230 cement mortar flowability measurement method.

As the Control Group is alkali activated fly ash without adding water reducers, it is named AAF.

### Embodiment 1

The components, parts by mass and test methods of the low-calcium AAM are the same as those in the Control Group, except that SF is added at 0.5 parts by mass.

The SF, purchased from Science and Technology Metallurgical Company, consists of white spherical particles with purity>99%.

The above materials are tested according to the following steps to determine a water reducer suitable for the low-calcium AAM, as shown in FIG. 1, including the following steps:
(1) weighing the materials according to 0.5 parts of the SF and 100 parts of fly ash, and using an electronic balance to weigh the materials, and the weighing balance accuracy of the materials is ±0.01 g;
(2) putting the weighed SF and fly ash into a blender, and stirring for 1 min until uniform;
(3) weighing 27.1 parts of sodium silicate solution and 10.9 parts of sodium hydroxide solution (14 M), and using the electronic balance to weigh the materials, with the weighing balance accuracy of ±0.01 g;
(4) preparing an alkaline solution, mixing 27.1 parts of sodium silicate solution and 10.9 parts of sodium hydroxide solution (14 M) and uniformly stirring;
(5) pouring the alkaline solution prepared in the step (4) into the mixed fly ash and SF in the step (2), and using a blender to stir for 3 min until a uniform paste appears; and
(6) using a cement flowability tester (jump table) to test the flowability of the pasty AAM stirred in the step (5) according to ASTM C230 cement mortar flowability measurement method.

As the additive used in Embodiment 1 is the SF with a dosage of 0.5%, it is named SFU-0.5%.

### Embodiment 2

The components, parts by mass and testing methods of the low-calcium AAM in this embodiment are the same as those in the Control Group, and the testing steps are the same as the ones in Embodiment 1, except that the SF is added at 1 part by mass.

As the additive used in Embodiment 2 is the SF with a dosage of 1%, it is named SFU-1%.

### Embodiment 3

The components, parts by mass and testing methods of the low-calcium AAM in this embodiment are the same as those in the Control Group, and the testing steps are the same as the ones in Embodiment 1, except that the SF is added at 2 parts by mass.

As the additive used in Embodiment 3 is the SF with a dosage of 2%, it is named SFU-2%.

### Embodiment 4

The components, parts by mass and testing methods of the low-calcium AAM in this embodiment are the same as the components, parts by mass and test methods in the Control Group, and the testing steps are the same as the testing steps in Embodiment 1, except that the SF is added at 3 parts by mass.

As the additive used in Embodiment 3 is the SF with a dosage of 3%, it is named SFU-3%.

### Embodiment 5

The components, parts by mass and testing methods of the low-calcium AAM in this embodiment are the same as those in the Control Group, and the testing steps are the same as the testing steps in Embodiment 1, except that the SF is added at 4 parts by mass.

As the additive used in Embodiment 3 is the SF with a dosage of 4%, it is named SFU-4%.

### Embodiment 6

The components, parts by mass and testing methods of the low-calcium AAM in this embodiment are the same as those in the Control Group, and the testing steps are the same as the testing steps in Embodiment 1, except that the SF is added at 5 parts.

As the additive used in Embodiment 3 is the SF with a dosage of 5%, it is named SFU-5%.

### Embodiment 7

The components, parts by mass and testing methods of the low-calcium AAM in this embodiment are the same as those in the Control Group, and the testing steps are the same as the testing steps in Embodiment 1, except that the SF is added at 6 parts.

As the additive used in Embodiment 3 is the SF with a dosage of 6%, it is named SFU-6%.

### Comparative Example 1

The components, parts by mass, and test steps and methods of the low-calcium AAM are the same as those in Embodiment 1, except that the SF is replaced by naphthalene.

Where the naphthalene is brownish yellow powder, purchased from Shanghai Chenqi Chemical Technology Co., Ltd. (CQJ-NX).

Because the additive used in Comparative Example 1 is naphthalene with a dosage of 0.5%, it is named as N-0.5%.

### Comparative Example 2

The components, parts by mass, and test steps and methods are the same as those in Embodiment 2, except that the SF is replaced by the naphthalene.

Because the additive used in Comparative Example 2 is the naphthalene with a dosage of 1%, it is named as N-1%.

### Comparative Example 3

The components, parts by mass, and test steps and methods are the same as those in Embodiment 3, except that the SF is replaced by the naphthalene water reducer.

Because the additive used in Comparative Example 3 is the naphthalene with a dosage of 2%, it is named as N-2%.

### Comparative Example 4

The components, parts by mass, and test steps and methods are the same as those in Embodiment 4, except that the SF is replaced by the naphthalene.

Because the additive used in Comparative Example 4 is the naphthalene with a dosage of 3%, it is named as N-3%.

### Comparative Example 5

The components, parts by mass, and test steps and methods are the same as those in Embodiment 5, except that the SF is replaced by the naphthalene.

Because the additive used in Comparative Example 5 is the naphthalene with a dosage of 4%, it is named as N-4%.

### Comparative Example 6

The components, parts by mass, and test steps and methods are the same as those in Embodiment 6, except that the SF is replaced by the naphthalene.

Because the additive used in Comparative Example 6 is the naphthalene with a dosage of 5%, it is named as N-5%.

### Comparative Example 7

The components, parts by mass, and test steps and methods are the same as those in Embodiment 7, except that the SF is replaced by the naphthalene.

Because the additive used in Comparative Example 7 is the naphthalene with a dosage of 6%, it is named as N-6%.

### Comparative Example 8

The components, parts by mass, test steps and methods are the same as those in Embodiment 1, except that the SF is replaced by the borax.

Where the borax is colorless and transparent crystalline powder, purchased from Sinopharm Chemical Reagents Co., Ltd., (chemical formula Na₂B₄O₇·10H₂O).

Because the additive used in Comparative Example 9 is the borax with a dosage of 0.5%, it is named as B-0.5%.

### Comparative Example 9

The components, parts by mass, and test steps and methods are the same as those in Embodiment 2, except that the SF is replaced by the borax.

Because the additive used in Comparative Example 9 is the borax with a dosage of 1%, it is named as B-1%.

### Comparative Example 10

The components, parts by mass, and test steps and methods are the same as those in Embodiment 3, except that the SF is replaced by the borax.

Because the additive used in Comparative Example 10 is the borax with a dosage of 2%, it is named as B-2%.

### Comparative Example 11

The components, parts by mass, and test steps and methods are the same as those in Embodiment 4, except that the SF is replaced by the borax.

Because the additive used in Comparative Example 11 is the borax with a dosage of 3%, it is named as B-3%.

### Comparative Example 12

The components, parts by mass, and test steps and methods are the same as those in Embodiment 5, except the SF is replaced by the borax.

Because the additive used in Comparative Example 12 is the borax with a dosage of 4%, it is named as B-4%.

### Comparative Example 13

The components, parts by mass, and test steps and methods are the same as those in Embodiment 6, except the SF is replaced by the borax.

Because the additive used in Comparative Example 13 is the borax with a dosage of 5%, it is named as B-5%.

### Comparative Example 14

The components, parts by mass, and test steps and methods are the same as those in Embodiment 7, except the SF is replaced by the borax.

Because the additive used in Comparative Example 14 is the borax with a dosage of 6%, it is named as B-6%.

### Comparative Example 15

The components, parts by mass, and test steps and methods are the same as those in Embodiment 1, except that the SF is replaced by the sodium hexametaphosphate.

Where sodium hexametaphosphate is colorless and transparent flake/crystal, produced by Xilong Chemical Company (analytical grade).

As the additive used in Comparative Example 15 is sodium hexametaphosphate with a dosage of 0.5%, it is named as SH-0.5%.

### Comparative Example 16

The components, parts by mass, and test steps and methods are the same as those in Embodiment 2, except the SF is replaced by the sodium hexametaphosphate.

As the additive used in Comparative Example 16 is sodium hexametaphosphate with a dosage of 1%, it is named as SH-1%.

### Comparative Example 17

The components, parts by mass, and test steps and methods are the same as those in Embodiment 3, except the SF is replaced by the sodium hexametaphosphate.

As the additive used in Comparative Example 17 is sodium hexametaphosphate with a dosage of 2%, it is named as SH-2%.

### Comparative Example 18

The components, parts by mass, and test steps and methods are the same as those in Embodiment 4, except the SF is replaced by the sodium hexametaphosphate.

As the additive used in Comparative Example 18 is sodium hexametaphosphate with a dosage of 3%, it is named as SH-3%.

### Comparative Example 19

The components, parts by mass, and test steps and methods are the same as those in Embodiment 5, except the SF is replaced by the sodium hexametaphosphate.

As the additive used in Comparative Example 19 is sodium hexametaphosphate with a dosage of 4%, it is named as SH-4%.

### Comparative Example 20

The components, parts by mass, and test steps and methods are the same as those in Embodiment 6, except the SF is replaced by the sodium hexametaphosphate.

As the additive used in Comparative Example 20 is sodium hexametaphosphate with a dosage of 5%, it is named as SH-5%.

### Comparative Example 21

The components, parts by mass, and test steps and methods are the same as those in Embodiment 7, except the SF is replaced by the sodium hexametaphosphate.

As the additive used in Comparative Example 21 is sodium hexametaphosphate with a dosage of 6%, it is named as SH-6%.

### Comparative Example 22

The components, parts by mass, and test steps and methods are the same as those in Embodiment 1, except the SF is replaced by the polycarboxylic acid.

Where the polycarboxylic acid is white solid powder, purchased from Shanghai Chenqi Chemical Technology Co., Ltd. (Sika-540P).

Because the additive used in Comparative Example 22 is polycarboxylic acid with a dosage of 0.5%, it is named as PC-0.5%.

### Comparative Example 23

The components, parts by mass, and test steps and methods are the same as those in Embodiment 2, except the SF is replaced by the polycarboxylic acid.

Because the additive used in Comparative Example 23 is polycarboxylic acid with a dosage of 1%, it is named as PC-1%.

### Comparative Example 24

The components, parts by mass, and test steps and methods are the same as those in Embodiment 3, except the SF is replaced by the polycarboxylic acid.

Because the additive used in Comparative Example 24 is polycarboxylic acid with a dosage of 2%, it is named as PC-2%.

### Comparative Example 25

The components, parts by mass, and test steps and methods are the same as those in Embodiment 4, except the SF is replaced by the polycarboxylic acid.

Because the additive used in Comparative Example 25 is polycarboxylic acid with a dosage of 3%, it is named as PC-3%.

### Comparative Example 26

The components, parts by mass, and test steps and methods are the same as those in Embodiment 5, except the SF is replaced by the polycarboxylic acid.

Because the additive used in Comparative Example 26 is polycarboxylic acid with a dosage of 4%, it is named as PC-4%.

### Comparative Example 27

The components, parts by mass, and test steps and methods are the same as those in Embodiment 6, except the SF is replaced by the polycarboxylic acid.

Because the additive used in Comparative Example 27 is polycarboxylic acid with a dosage of 5%, it is named as PC-5%.

### Comparative Example 28

The components, parts by mass, and test steps and methods are the same as those in Embodiment 7, except the SF is replaced by the polycarboxylic acid.

Because the additive used in Comparative Example 28 is polycarboxylic acid with a dosage of 6%, it is named as PC-6%.

### Comparative Example 29

The components, parts by mass, and test steps and methods are the same as those in Embodiment 1, except the SF is replaced by the silica sand.

Where the silica sand contains white spherical particles, with a purity of >99%.

As the additive used in Comparative Example 29 is silica sand with a dosage of 0.5%, it is named as SFL-0.5%.

### Comparative Example 30

The components, parts by mass, and test steps and methods are the same as those in Embodiment 2, except the SF is replaced by the silica sand.

As the additive used in Comparative Example 30 is silica sand with a dosage of 1%, it is named as SFL-1%.

### Comparative Example 31

The components, parts by mass, and test steps and methods are the same as those in Embodiment 3, except the SF is replaced by the silica sand.

As the additive used in Comparative Example 31 is silica sand with a dosage of 2%, it is named as SFL-2%.

### Comparative Example 32

The components, parts by mass, and test steps and methods are the same as those in Embodiment 4, except the SF is replaced by the silica sand.

As the additive used in Comparative Example 32 is silica sand with a dosage of 3%, it is named as SFL-3%.

### Comparative Example 33

The components, parts by mass, and test steps and methods are the same as those in Embodiment 5, except the SF is replaced by the silica sand.

As the additive used in Comparative Example 33 is silica sand with a dosage of 4%, it is named as SFL-4%.

### Comparative Example 34

The components, parts by mass, and test steps and methods are the same as those in Embodiment 6, except the SF is replaced by the silica sand.

As the additive used in Comparative Example 34 is silica sand with a dosage of 5%, it is named as SFL-5%.

### Comparative Example 35

The components, parts by mass, and test steps and methods are the same as those in Embodiment 7, except the SF is replaced by the silica sand.

As the additive used in Comparative Example 35 is silica sand with a dosage of 6%, it is named as SFL-6%.

A fly ash-based low-calcium AAM is formulated according to the following parts by mass: (1) 100 parts of fly ash; (2) 27.1 parts of sodium silicate solution; (3) 10.9 parts of sodium hydroxide solution (14 M).

Where, the particle size distribution of the fly ash is shown in FIG. 4. The mass percentage of each oxide in the chemical composition of the fly ash is as follows: 54.17% of SiO₂, 31.57% of Al₂O₃, 3.48% of Fe₂O₃, 2.98% of CaO, 1.90% of K₂O, 1.37% of TiO₂, 1.22% of MgO, and 3.31% of others.

Where, the sodium silicate solution is produced by Jiashan Yourui Refractory Co., Ltd., and in the chemical composition, SiO₂ accounts for 27.3%, Na₂O accounts for 8.54%, and the modulus is 3.3.

Where, the sodium hydroxide solution is a liquid with a concentration of 14 M prepared by sodium hydroxide solid particles with a purity≥96%.

### Control Group

A method for preparing fly ash-based low-calcium AAM, as shown in FIG. 1, includes the following steps:
(1) weighing 100 parts of fly ash, and using an electronic balance to weigh the materials, where the weighing balance accuracy of the materials is ±0.01 g;
(2) weighing 27.1 parts of sodium silicate solution and 10.9 parts of sodium hydroxide solution (14 M), and using the electronic balance to weigh the material, the weighing balance accuracy of the material is ±0.01 g;
(3) preparing an alkaline solution, mixing 27.1 parts of sodium silicate solution and 10.9 parts of sodium hydroxide solution (14 M) and uniformly stirring;
(4) pouring the alkaline solution prepared in the step (3) into the weighed fly ash in the step (1), and using a blender to stir for 3 min until a uniform paste appears;
(5) casting the pasty AAM stirred in the step (4) into a plastic mold, and manually vibrating to remove air bubbles;
(6) putting the AAM in the step (5) into curing chamber for 72 h at a constant temperature of 75° C. and 35% humidity; and
(7) testing the compressive strength of the AAM specimens cured in the step (6) with a compression testing machine (YAW-300) according to ASTM C 109-93.

As the Control Group is alkali activated fly ash without adding water reducers, it is named AAF.

### Embodiment 8

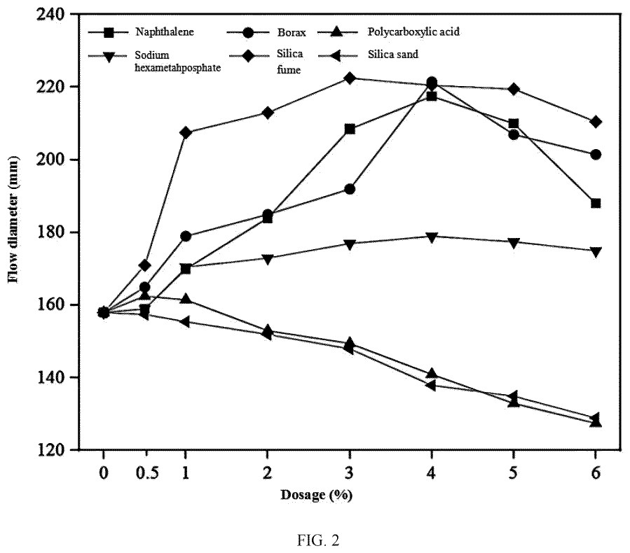

In this embodiment, the components, parts by mass, and test steps and methods are the same as those in the Control Group, except that the SF is added at 3 parts. This dosage resulted in the highest flowability (as shown in FIG. 2).

The SF, purchased from Science and Technology Metallurgical Company, consists of white spherical particles with purity>99%.

The above materials are tested according to the following steps to determine a water reducer suitable for the low-calcium AAM, as shown in FIG. 1, including the following steps:
(1) weighing 0.5 parts of the SF and 100 parts of fly ash, and using an electronic balance to weigh the materials, and the weighing balance accuracy of the materials is +0.01 g;
(2) mixing the weighed SF and fly ash, and putting them into a blender, and stirring for 1 min until uniform;
(3) weighing 27.1 parts of sodium silicate solution and 10.9 parts of sodium hydroxide solution (14 M), and using the electronic balance to weigh the materials, with the weighing balance accuracy of ±0.01 g;
(4) preparing an alkaline solution, mixing 27.1 parts of sodium silicate solution and 10.9 parts of sodium hydroxide solution (14 M) and uniformly stirring;
(5) pouring the alkaline solution prepared in the step (4) into the mixed fly ash and SF in the step (2), and using a blender to stir for 3 min until a uniform paste appears;
(6) casting the pasty AAM stirred in the step (5) into a plastic mold, and manually vibrating to remove air bubbles;
(7) putting the AAM in the step (6) into a curing chamber for 72 h at a constant temperature of 75° C. and 35% humidity; and
(8) testing the compressive strength of the AAM test block cured in the step (7) with a compression testing machine (YAW-300) according to ASTM C 109-93.

As the additive used in the embodiment is the SF with a dosage of 3%, it is named SFU-3%.

### Comparative Example 36

The components, parts by mass, and test steps and methods are the same as those in Embodiment 8, except the SF is replaced by naphthalene and the naphthalene is added at 4 parts. This dosage resulted in the highest flowability (as shown in FIG. 2).

Where the naphthalene is brownish yellow powder, purchased from Shanghai Chenqi Chemical Technology Co., Ltd. (CQJ-NX).

Because the additive used in Comparative Example 36 is naphthalene with a dosage of 4%, it is named as N-4%.

### Comparative Example 37

The components, parts by mass, and test steps and methods are the same as those in Embodiment 8, except the SF is replaced by the borax with 4 parts by mass. This dosage resulted in the highest flowability (as shown in FIG. 2).

Where the borax is colorless and transparent crystalline powder, purchased from Sinopharm Chemical Reagents Co., Ltd., (chemical formula Na₂B₄O₇·10H₂O).

Because the additive used in Comparative Example 37 is the borax with the dosage of 4%, it is named as B-4%.

### Comparative Example 38

The components, parts by mass, and test steps and methods are the same as those in Embodiment 8, except the SF is replaced by the sodium hexametaphosphate added at 4 parts. This dosage resulted in the highest flowability (as shown in FIG. 2).

Where the sodium hexametaphosphate is colorless and transparent flake/crystal, produced by Xilong Chemical Company (analytical grade).

Because the additive used in Comparative Example 38 is the sodium hexametaphosphate with a dosage of 4%, it is named as SH-4%.

### Comparative Example 39

The components, parts by mass, and test steps and methods are the same as those in Embodiment 8, except the SF is replaced by the polycarboxylic acid added at 0.5 parts. This dosage resulted in the highest flowability (as shown in FIG. 2).

Where the polycarboxylic acid is white solid powder, purchased from Shanghai Chenqi Chemical Technology Co., Ltd. (Sika-540P).

Because the additive used in Comparative Example 39 is the polycarboxylic acid with a dosage of 0.5%, it is named as PC-0.5%.

FIG. 2 shows the results of flowability test. It may be seen from FIG. 2 that the addition of the SF leads to the greatest improvements in flowability. At a dosage of 3%, the flow diameter of AAF with SF in the present disclosure reached 222.5 mm. Compared with the AAF without water reducer, the flowability is increased by 40.8%. In contrast, naphthalene, borax, sodium hexametaphosphate and polycarboxylic acid could only increase flowability by 40.2%, 37.6%, 13.3% and 0.8% at 4%, 4%, 4% and 0.5%, respectively. Silica sand has no water reducing capacity at all.

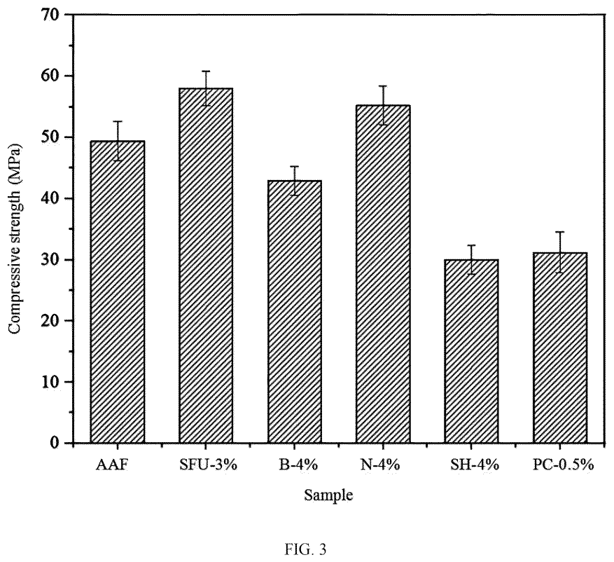

According to the compressive strength test results in FIG. 3, the addition of silica fume improvement in mechanical properties. When the dosage is 3%, the compressive strength reaches 58 MPa, which is 17.3% higher than the compressive strength of AAM without the water-reducing admixture. However, the naphthalene caused only 11.7% strength increase. The other additives all reduced AAF compressive strength.

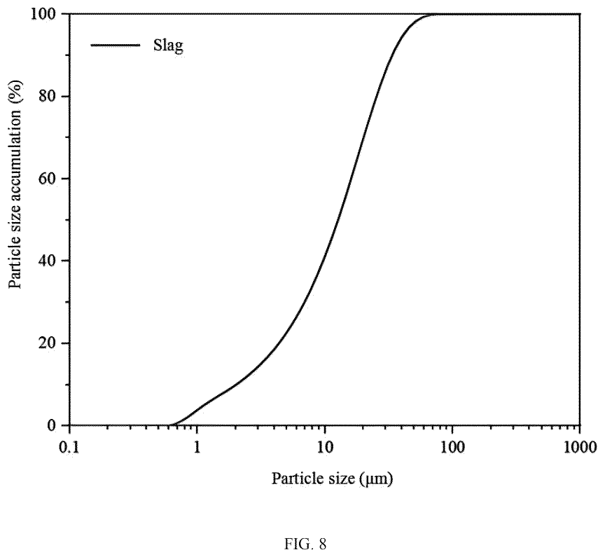

A slag-based high-calcium AAM is formulated according to the following parts by mass: (1) 100 parts of slag; (2) 14.6 parts of sodium silicate solution; (3) 1.8 parts of sodium hydroxide particles; and (4) 18.6 parts of distilled water.

Where the slag is the precursor material for preparing AAM, and the particle size distribution is shown in FIG. 8. the mass percentage of each oxide in the chemical composition of the slag is as follows: 40.43% of CaO, 30.46% of SiO₂, 15.81% of Al₂O₃, 9.42% of MgO, 0.281% of Fc₂O₃, 0.423% of K₂O, 0.673% of TiO₂, 0.52% of MnO, 0.499% of Na₂O, 1.16% of S, 0.0549% of SrO, 0.0467% of C1, 0.0391% of ZrO₂, 0.0389% of BaO, 0.017% of P₂O₅, 0.0084% of V₂O₅, 0.0083% of Y₂O₃, 0.0069% of CeO₂, and 0.0012% of CuO.

Where, the sodium silicate solution is produced by Jiashan Yourui Refractory Co., Ltd., and in the chemical composition, SiO₂ accounts for 27.3%, Na₂O accounts for 8.54%, and the modulus is 3.3.

Where, the sodium hydroxide solution is a liquid with a concentration of 14 M prepared by sodium hydroxide solid particles with a purity≥96%.

### Control Group 2

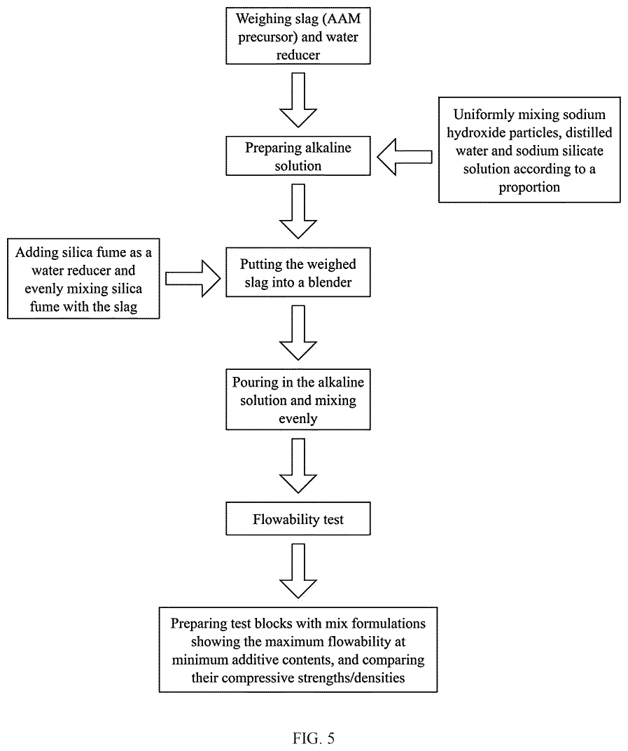

A method for preparing of the slag-based high-calcium AAM, as shown in FIG. 5, includes the following steps:
(1) weighing 100 parts of slag, and using an electronic balance to weigh the materials, where the weighing balance accuracy of the materials is ±0.01 g;
(2) weighing 14.6 parts of sodium silicate solution, 1.8 parts of sodium hydroxide particles and 18.6 parts of distilled water, and using the electronic balance to weigh the materials, with the weighing balance accuracy of ±0.01 g;
(3) preparing an alkaline solution: mixing 14.6 parts of sodium silicate solution, 1.8 parts of sodium hydroxide particles and 18.6 parts of distilled water and uniformly stirring;
(4) pouring the alkaline solution prepared in the step (3) into the slag weighed in the step (1), and stirring for 1 min with a stirrer until a uniform paste appears; and
(5) using a cement flowability tester (jump table) to test the flowability of the pasty AAM stirred in the step (4) according to ASTM C230 cement mortar flowability measurement method.

Because the material used in this Control Group 2 is alkali activated slag, it is named AAS.

### Embodiment 2-1

The components, parts by mass and test methods are the same as those in Control Group 2, except that the SF is added at 0.5 parts by mass.

Where the SF, purchased from Science and Technology Metallurgical Company, consists of spherical white powder with purity>99%.

The above materials are tested according to the following steps to determine a water reducer suitable for the high-calcium AAM, as shown in FIG. 5, including the following steps:
(1) weighing 0.5 parts of the SF and 100 parts of slag using an electronic balance, where the weighing balance accuracy of the materials is ±0.01 g;
(2) putting the weighed SF with slag, into a stirrer, and stirring the mixture for 1 min until uniform;
(3) weighing 14.6 parts of sodium silicate solution, 1.8 parts of sodium hydroxide particles and 18.6 parts of distilled water, and using the electronic balance to weigh the materials, with the weighing balance accuracy of +0.01 g;
(4) preparing an alkaline solution: mixing 14.6 parts of sodium silicate solution, 1.8 parts of sodium hydroxide particles and 18.6 parts of distilled water and uniformly stirring;
(5) pouring the alkaline solution prepared in the step (4) into the mixture in the step (2), and using a blender to stir for 3 min until a uniform paste appears; and
(6) using a cement flowability tester (jump table) to test the flowability of the pasty AAM stirred in the step (5) according to ASTM C230 cement mortar flowability measurement method.

Because the additive used in Embodiment 2-1 is the SF with a dosage of 0.5%, it is named as 2-SFU-0.5%.

### Embodiment 2-2

The components, parts by mass and test methods are the same as those in Embodiment 2-1, except that the SF is added at 1 part.

Because the additive used in Embodiment 2-2 is the SF with a dosage of 1%, it is named as 2-SFU-1%.

### Embodiment 2-3

The components, parts by mass and test methods are the same as those in Embodiment 2-1, except that the SF is added at 2 parts.

Because the additive used in Embodiment 2-3 is the SF with a dosage of 2%, it is named as 2-SFU-2%.

### Embodiment 2-4

The components, parts by mass and test methods are the same as those in Embodiment 2-1, except that the SF is added at 3 parts.

Because the additive used in Embodiment 2-4 is the SF with a dosage of 3%, it is named as 2-SFU-3%.

### Embodiment 2-5

The components, parts by mass and test methods are the same as those in Embodiment 2-1, except that the SF is added at 4 parts.

Because the additive used in Embodiment 2-5 is the SF with a dosage of 4%, it is named as 2-SFU-4%.

### Embodiment 2-6

The components, parts by mass and test methods are the same as those in Embodiment 2-1, except that the SF is added at 5 parts.

Because the additive used in Embodiment 2-6 is the SF with a dosage of 5%, it is named as 2-SFU-5%.

### Embodiment 2-7

The components, parts by mass and test methods are the same as those in Embodiment 2-1, except that the SF is added at 6 parts.

Because the additive used in Embodiment 2-7 is the SF with a dosage of 6%, it is named as 2-SFU-6%.

### Comparative Example 2-1

The components, parts by mass and test methods are the same as those in Embodiment 2-1, except that the SF is replaced by naphthalene.

Where the naphthalene is brownish yellow powder, purchased from Shanghai Chenqi Chemical Technology Co., Ltd. (CQJ-NX).

Because the additive used in Comparative Example 2-1 is naphthalene with a dosage of 0.5%, it is named as 2-N-0.5%.

### Comparative Example 2-2

The components, parts by mass and test methods are the same as those in Embodiment 2-2, except that the SF is replaced by naphthalene.

Because the additive used in Comparative Example 2-2 is naphthalene with a dosage of 1%, it is named as 2-N-1%.

### Comparative Example 2-3

The components, parts by mass and test methods are the same as those in Embodiment 2-3, except that the SF is replaced by naphthalene.

Because the additive used in Comparative Example 2-3 is naphthalene with a dosage of 2%, it is named as 2-N-2%.

### Comparative Example 2-4

The components, parts by mass and test methods are the same as those in Embodiment 2-4, except that the SF is replaced by naphthalene.

Because the additive used in Comparative Example 2-4 is naphthalene with a dosage of 3%, it is named as 2-N-3%.

### Comparative Example 2-5

The components, parts by mass and test methods are the same as those in Embodiment 2-5, except that the SF is replaced by naphthalene.

Because the additive used in Comparative Example 2-5 is naphthalene with a dosage of 4%, it is named as 2-N-4%.

### Comparative Example 2-6

The components, parts by mass and test methods are the same as those in Embodiment 2-6, except that the SF is replaced by naphthalene.

Because the additive used in Comparative Example 2-6 is naphthalene with a dosage of 5%, it is named as 2-N-5%.

### Comparative Example 2-7

The components, parts by mass and test methods are the same as those in Embodiment 2-7, except that the SF is replaced by naphthalene.

Because the additive used in Comparative Example 2-7 is naphthalene with a dosage of 6%, it is named as 2-N-6%.

### Comparative Example 2-8

The components, parts by mass and test methods in this example are the same as those in Embodiment 2-1, except that the SF is replaced by the borax.

Where the borax is colorless and transparent crystalline powder, purchased from Sinopharm Chemical Reagents Co., Ltd., (chemical formula Na₂B₄O₇·10H₂O).

Because the additive used in Comparative Example 2-8 is the borax with a dosage of 0.5%, it is named as 2-B-0.5%.

### Comparative Example 2-9

The components, parts by mass and test methods in this example are the same as those in Embodiment 2-2, except that the SF is replaced by the borax.

Because the additive used in Comparative Example 2-9 is the borax with a dosage of 1%, it is named as 2-B-1%.

### Comparative Example 2-10

The components, parts by mass and test methods in this example are the same as those in Embodiment 2-3, except that the SF is replaced by the borax.

Because the additive used in Comparative Example 2-10 is the borax with a dosage of 2%, it is named as 2-B-2%.

### Comparative Example 2-11

The components, parts by mass and test methods in this example are the same as those in Embodiment 2-4, except that the SF is replaced by the borax.

Because the additive used in Comparative Example 2-11 is the borax with a dosage of 3%, it is named as 2-B-3%.

### Comparative Example 2-12

The components, parts by mass and test methods in this example are the same as those in Embodiment 2-5, except that the SF is replaced by the borax.

Because the additive used in Comparative Example 2-12 is the borax with a dosage of 4%, it is named as 2-B-4%.

### Comparative Example 2-13

The components, parts by mass and test methods in this example are the same as those in Embodiment 2-6, except that the SF is replaced by the borax.

Because the additive used in Comparative Example 2-13 is the borax with a dosage of 5%, it is named as 2-B-5%.

### Comparative Example 2-14

The components, parts by mass and test methods in this example are the same as those in Embodiment 2-7, except that the SF is replaced by the borax.

Because the additive used in Comparative Example 2-14 is the borax with a dosage of 6%, it is named as 2-B-6%.

### Comparative Example 2-15

The components, parts by mass and test methods in this example are the same as those in Embodiment 2-1, except that the SF is replaced by sodium hexametaphosphate.

Where sodium hexametaphosphate is colorless and transparent flake/crystal, produced by Xilong Chemical Company (analytical grade).

Because the additive used in Comparative Example 2-15 is sodium hexametaphosphate with a dosage of 0.5%, it is named as 2-SH-0.5%.

### Comparative Example 2-16

The components, parts by mass and test methods in this example are the same as those in Embodiment 2-2, except that the SF is replaced by sodium hexametaphosphate.

Because the additive used in Comparative Example 2-16 is sodium hexametaphosphate with a dosage of 1%, it is named as 2-SH-1%.

### Comparative Example 2-17

The components, parts by mass and test methods in this example are the same as those in Embodiment 2-3, except that the SF is replaced by sodium hexametaphosphate.

Because the additive used in Comparative Example 2-17 is sodium hexametaphosphate with a dosage of 2%, it is named as 2-SH-2%.

### Comparative Example 2-18

The components, parts by mass and test methods in this example are the same as those in Embodiment 2-4, except that the SF is replaced by sodium hexametaphosphate.

Because the additive used in Comparative Example 2-18 is sodium hexametaphosphate with a dosage of 3%, it is named as 2-SH-3%.

### Comparative Example 2-19

The components, parts by mass and test methods in this example are the same as those in Embodiment 2-5, except that the SF is replaced by sodium hexametaphosphate.

Because the additive used in Comparative Example 2-19 is sodium hexametaphosphate with a dosage of 4%, it is named as 2-SH-4%.

### Comparative Example 2-20

The components, parts by mass and test methods in this example are the same as those in Embodiment 2-6, except that the SF is replaced by sodium hexametaphosphate.

Because the additive used in Comparative Example 2-20 is sodium hexametaphosphate with a dosage of 5%, it is named as 2-SH-5%.

### Comparative Example 2-2

The components, parts by mass and test methods in this example are the same as those in Embodiment 2-7, except that the SF is replaced by sodium hexametaphosphate.

Because the additive used in Comparative Example 2-21 is sodium hexametaphosphate with a dosage of 6%, it is named as 2-SH-6%.

### Comparative Example 2-22

The components, parts by mass and test methods in this example are the same as those in Embodiment 2-1, except that the SF is replaced by polycarboxylic acid.

Where the polycarboxylic acid is white solid powder, purchased from Shanghai Chenqi Chemical Technology Co., Ltd. (Sika-540P).

Because the additive used in Comparative Example 2-22 is polycarboxylic acid with a dosage of 0.5%, it is named as 2-PC-0.5%.

### Comparative Example 2-23

The components, parts by mass and test methods in this example are the same as those in Embodiment 2-2, except that the SF is replaced by polycarboxylic acid.

Because the additive used in Comparative Example 2-23 is polycarboxylic acid with a dosage of 1%, it is named as 2-PC-1%.

### Comparative Example 2-24

The components, parts by mass and test methods in this example are the same as those in Embodiment 2-3, except that the SF is replaced by polycarboxylic acid.

Because the additive used in Comparative Example 2-24 is polycarboxylic acid with a dosage of 2%, it is named as 2-PC-2%.

### Comparative Example 2-25

The components, parts by mass and test methods in this example are the same as those in Embodiment 2-4, except that the SF is replaced by polycarboxylic acid.

Because the additive used in Comparative Example 2-25 is polycarboxylic acid with a dosage of 3%, it is named as 2-PC-3%.

### Comparative Example 2-26

The components, parts by mass and test methods in this example are the same as those in Embodiment 2-5, except that the SF is replaced by polycarboxylic acid.

Because the additive used in Comparative Example 2-26 is polycarboxylic acid with a dosage of 4%, it is named as 2-PC-4%.

### Comparative Example 2-27

The components, parts by mass and test methods in this example are the same as those in Embodiment 2-6, except that the SF is replaced by polycarboxylic acid.

Because the additive used in Comparative Example 2-27 is polycarboxylic acid with a dosage of 5%, it is named as 2-PC-5%.

### Comparative Example 2-28

The components, parts by mass and test methods in this example are the same as those in Embodiment 2-7, except that the SF is replaced by polycarboxylic acid.

Because the additive used in Comparative Example 2-28 is polycarboxylic acid with a dosage of 6%, it is named as 2-PC-6%.

### Comparative Example 2-29

The components, parts by mass and test methods in this example are the same as those in Embodiment 2-1, except that the SF is replaced by silica sand.

Where the silica sand, purchased from Beasley New Materials Company, consists of white spherical powder with a purity of >99%.

Because the additive used in Comparative Example 2-29 is silica sand with a dosage of 0.5%, it is named as 2-SFL-0.5%.

### Comparative Example 2-30

The components, parts by mass and test methods in this example are the same as those in Embodiment 2-2, except that the SF is replaced by silica sand.

Where the silica sand contains white spherical particles with purity>99%.

Because the additive used in Comparative Example 2-30 is silica sand with a dosage of 1%, it is named as 2-SFL-1%.

### Comparative Example 2-31

The components, parts by mass and test methods in this example are the same as those in Embodiment 2-3, except that the SF is replaced by silica sand.

Where the silica sand contains white spherical particles with purity>99%.

Because the additive used in Comparative Example 2-31 is sand with a dosage of 2%, it is named as 2-SFL-2%.

### Comparative Example 2-32

The components, parts by mass and test methods in this example are the same as those in Embodiment 2-4, except that the SF is replaced by silica sand.

Where the silica sand contains white spherical particles with purity>99%.

Because the additive used in Comparative Example 2-32 is silica sand with a dosage of 3%, it is named as 2-SFL-3%.

### Comparative Example 2-33

The components, parts by mass and test methods in this example are the same as those in Embodiment 2-5, except that the SF is replaced by silica sand.

Where the silica sand contains white spherical particles with purity>99%.

Because the additive used in Comparative Example 2-33 is silica sand with a dosage of 4%, it is named as 2-SFL-4%.

### Comparative Example 2-34

The components, parts by mass and test methods in this example are the same as those in Embodiment 2-6, except that the SF is replaced by silica sand.

Where the silica sand contains white spherical particles with purity>99%.

Because the additive used in Comparative Example 2-34 is silica sand with a dosage of 5%, it is named as 2-SFL-5%.

### Comparative Example 2-35

The components, parts by mass and test methods in this example are the same as those in Embodiment 2-7, except that the SF is replaced by silica sand.

Where the silica sand contains white spherical particles with purity>99%.

Because the additive used in Comparative Example 2-35 is silica sand with a dosage of 6%, it is named as 2-SFL-6%.

A slag-based high-calcium AAM is formulated according to the following parts by mass: (1) 100 parts of slag; (2) 14.6 parts of sodium silicate solution; (3) 1.8 parts of sodium hydroxide particles; (4) 18.6 parts of distilled water.

Where the slag is the precursor material for preparing AAM, and its particle size distribution is shown in FIG. 8, with chemical composition as follows: 40.43% of CaO, 30.46% of SiO₂, 15.81% of Al₂O₃, 9.42% of MgO, 0.281% of Fe₂O₃, 0.423% of K₂O, 0.673% of TiO₂, 0.52% of MnO, 0.499% of Na₂O, 1.16% of S, 0.0549% of SrO, 0.0467% of Cl, 0.0391% of ZrO₂, 0.0389% of BaO, 0.017% of P₂O₅, 0.0084% of V₂O₅, 0.0083% of Y₂O₃, 0.0069% of CeO₂, and 0.0012% of CuO.

Where, the sodium silicate solution is produced by Jiashan Yourui Refractory Co., Ltd., and in the chemical composition, SiO₂ accounts for 27.3%, Na₂O accounts for 8.54%, and the modulus is 3.3.

Where, the sodium hydroxide particles are used for preparing the alkaline solution, and the purity of the sodium hydroxide particles is ≥96%.

Where, distilled water is used to prepare the alkaline solution.

### Control Group 2

A method for preparing the slag-based high-calcium AAM, as shown in FIG. 5, including the following steps:
(1) weighing materials according to 100 parts of slag, and using an electronic balance to weigh the materials, where the weighing balance accuracy of the materials is +0.01 g;
(2) weighing the materials according to 14.6 parts of sodium silicate solution, 1.8 parts of sodium hydroxide particles and 18.6 parts of distilled water, and using the electronic balance to weigh the materials, with the weighing balance accuracy of +0.01 g;
(3) preparing an alkaline solution: mixing 14.6 parts of sodium silicate solution, 1.8 parts of sodium hydroxide particles and 18.6 parts of distilled water and uniformly stirring;
(4) pouring the alkaline solution prepared in the step (3) into the slag weighed in the step (1), and stirring for 1 min until a uniform paste appears;
(5) casting the pasty AAM stirred in the step (5) into a plastic mold, and manually vibrating to remove air bubbles;
(6) curing the AAM of the step (5) at room temperature (20±2° C.) and 99% humidity 28 d as per EN 196-1.
(7) testing the compressive strength of the AAM specimens cured in the step (6) with a compression testing machine (YAW-300) according to ASTM C 109-93.

Because the material used in this Control Group 2 is alkali activated slag, it is named AAS.

### Embodiment 2-8

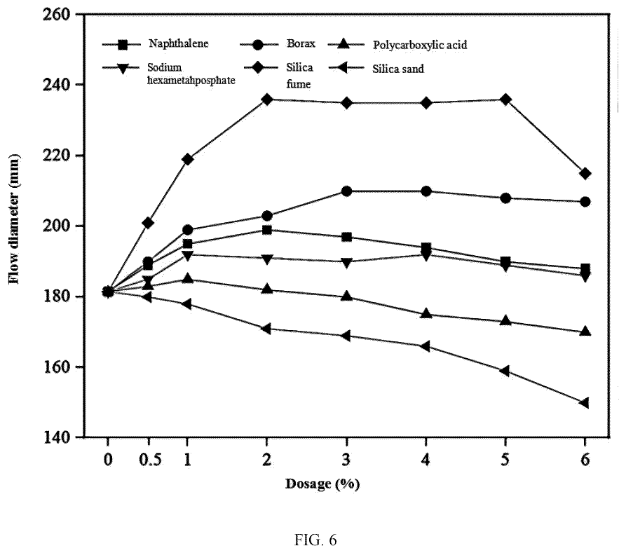

In this embodiment, the components, parts by mass, and test steps and methods are the same as those in the Control Group, except that the SF is added at 2 parts. This dosage resulted in the highest flowability (as shown in FIG. 6).

The SF consists of white spherical particles with purity>99%.

The above materials are tested according to the following steps to determine a water reducer suitable for the high-calcium AAM, as shown in FIG. 5, including the following steps:
(1) weighing 0.5 parts of SF and 100 parts of slag, and using an electronic balance to weigh the materials, where the weighing balance accuracy of the materials is +0.01 g;
(2) putting the weighed SF and slag into a stirrer, and stirring the mixture 1 min until the mixture is uniform;
(3) weighing 14.6 parts of sodium silicate solution, 1.8 parts of sodium hydroxide particles and 18.6 parts of distilled water, and using the electronic balance to weigh the materials, with the weighing balance accuracy of ±0.01 g;
(4) preparing an alkaline solution: mixing 14.6 parts of sodium silicate solution, 1.8 parts of sodium hydroxide particles and 18.6 parts of distilled water and uniformly stirring;
(5) pouring the alkaline solution prepared in the step (4) into the mixed slag and SF in the step (2), and using a blender to stir for 3 min until a uniform paste appears;
(6) casting the pasty AAM stirred in the step (5) into a plastic mold, and manually vibrating to remove air bubbles;
(7) curing the AAM of the step (6) at room temperature (20±2° C.) and 99% humidity 28 d as per EN 196-1; and
(8) testing the compressive strength of the AAM specimens cured in the step (7) with a compression testing machine (YAW-300) according to ASTM C 109-93.

Because the additive used in this embodiment is the SF with a dosage of 2%, it is named as 2-SFU-2%.

### Comparative Example 2-36

The components, parts by mass, and test steps and methods in this example are the same as those in Embodiment 2-8, except that the SF is replaced by naphthalene at 2 parts. This dosage resulted in the highest flowability (as shown in FIG. 6).

Where the naphthalene is brownish yellow powder, purchased from Shanghai Chenqi Chemical Technology Co., Ltd. (CQJ-NX).

Because the additive used in Comparative Example 2-36 is the naphthalene with a dosage of 2%, it is named as 2-N-2%.

### Comparative Example 2-37

The components, parts by mass, and test steps and methods in this example are the same as those in Embodiment 2-8, except that the SF is replaced by borax at 3 parts. This dosage resulted in the highest flowability (as shown in FIG. 6).

Where the borax is colorless and transparent crystalline powder, purchased from Sinopharm Chemical Reagents Co., Ltd., (chemical formula Na₂B₄O₇·10H₂O).

Because the additive used in Comparative Example 2-37 is the borax with a dosage of 3%, it is named as 2-B-3%.

### Comparative Example 2-38

The components, parts by mass, and test steps and methods in this example are the same as those in Embodiment 2-8, except that the SF is replaced by sodium hexametaphosphate at 2 parts. This dosage resulted in the highest flowability (as shown in FIG. 6).

Where sodium hexametaphosphate is colorless and transparent flake/crystal, produced by Xilong Chemical Company (analytical grade).

Because the additive used in Comparative Example 2-38 is the sodium hexametaphosphate with a dosage of 2%, it is named as 2-SH-2%.

### Comparative Example 2-39

The components, parts by mass, and test steps and methods in this example are the same as those in Embodiment 2-8, except that the SF is replaced by polycarboxylic acid at 1 part. This dosage resulted in the highest flowability (as shown in FIG. 6).

Where the polycarboxylic acid is white solid powder, purchased from Shanghai Chenqi Chemical Technology Co., Ltd. (Sika-540P).

The additive used in Comparative Example 39 is the polycarboxylic acid, and the dosage is 1%, so it is named as 2-PC-1%.

FIG. 6 shows the flowability test results. It may be seen from FIG. 6 that the addition of the SF leads to the greatest improvements in flowability. At a dosage of 2%, the flow diameter of AAS with SF in the present disclosure reached 236 mm, which is 30% higher than that of the plain AAS. In contrast, the naphthalene, borax, sodium hexametaphosphate and polycarboxylic acid could only increase flowability by 9.7%, 15.7%, 5.8% and 1.9% at 2%, 3%, 1% and 1%, respectively. Silica sand has no water reducing capacity at all.

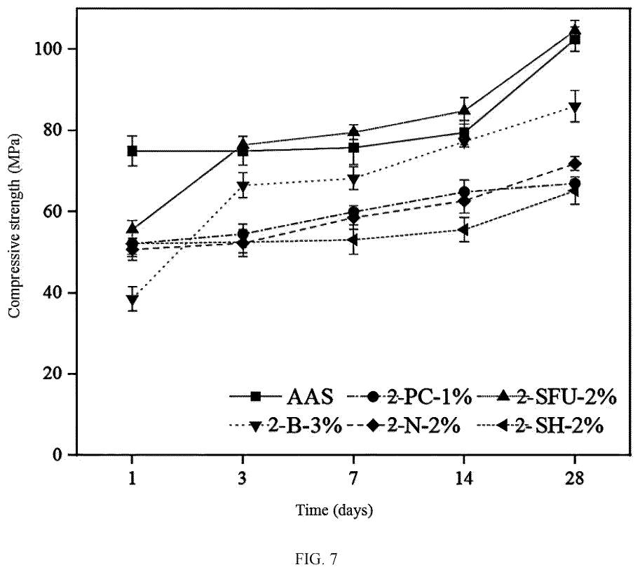

According to the test results of compressive strength in FIG. 7, the addition of the SF could largely keep the compressive strength of AAS above that of the plain AAS. At a dosage of 2%, although the initial compressive strength is lower than that of the plain AAS, it exceeded after three days and remained constantly above the strength of plain AAS, and finally reached 104.6 MPa at 28 day. The rest additives all reduced the compressive strength of AAS.

The embodiments of the present disclosure described above are only selected examples of the present disclosure and may not be used to confine the scope of implementation of the present disclosure. All necessary changes and improvements made according to the disclosure scope of the present disclosure should still fall within the coverage scope of the present disclosure.

What is claimed is:

1. A use of silica fume (SF) as water reducer, wherein the water reducer is used in at least one of a low-calcium alkali-activated material (AAM) or a high-calcium AAM.

2. The use of the SF as the water reducer according to claim 1, wherein at least one of the low calcium AAM is a fly ash-based low-calcium AAM, or the high calcium AAM is a slag-based high-calcium AAM.

3. The use of the SF as the water reducer according to claim 2, wherein fly ash in the fly ash-based low-calcium AAM is a coal fly ash, with chemical components as follows: 54.17 percent (%) of SiO₂, 31.57% of Al₂O₃, 3.48% of Fe₂O₃, 2.98% of CaO, 1.90% of K₂O, 1.37% of TiO₂, 1.22% of MgO, and 3.31% of others.

4. The use of the SF as the water reducer according to claim 2, wherein an S95 ground granulated blast furnace slag is an precursor for preparing the slag-based high-calcium AAM, with chemical components as follows: 40.43% of CaO, 30.46% of SiO₂, 15.81% of Al₂O₃, 9.42% of MgO, 0.281% of Fe₂O₃, 0.423% of K₂O, 0.673% of TiO₂, 0.52% of MnO, 0.499% of Na₂O, 1.16% of S, 0.0549% of SrO, 0.0467% of Cl, 0.0391% of ZrO₂, 0.0389% of BaO, 0.017% of P₂O₅, 0.0084% of V₂O₅, 0.0083% of Y₂O₃, 0.0069% of CeO₂, and 0.0012% of CuO.

5. A fly ash-based low-calcium alkali-activated material (AAM) with silica fume (SF) as a water reducer, wherein the fly ash-based low-calcium AAM is prepared from following materials: SF, fly ash and an alkaline solution.

6. The fly ash-based low-calcium AAM with the SF as the water reducer according to claim 5, wherein the alkaline solution comprises a sodium silicate solution and a sodium hydroxide solution, wherein according to parts by mass, the SF is 0.01-12 parts, the fly ash is 80-150 parts, the sodium silicate solution is 20-35 parts, and the sodium hydroxide solution is 8-15 parts.

7. The fly ash-based low-calcium AAM with the SF as the water reducer according to claim 6, wherein the sodium silicate solution comprises SiO₂ accounting for 27.3 weight percentages (wt %), Na₂O accounting for 8.54 weight percentages (wt %), and a modulus is 3.3; and the sodium hydroxide solution is a liquid with a concentration of 10-20 molality (M) prepared by sodium hydroxide solid particles with a purity≥96%.

8. A slag-based high-calcium alkali-activated material (AAM) with silica fume (SF) as a water reducer, wherein the slag-based high-calcium AAM is prepared from the following materials: SF, slag, and an alkaline solution.

9. The slag-based high-calcium AAM with the SF as the water reducer according to claim 8, wherein the alkaline solution comprises a sodium silicate solution and a sodium hydroxide solution, wherein according to parts by mass, the SF is 0.01-12 parts, the slag is 80-150 parts, the sodium silicate solution is 10-25 parts, sodium hydroxide solid particles of the sodium hydroxide solution are 4-10 parts, and distilled water is 10-16 parts.

10. The slag-based high-calcium AAM with the SF as the water reducer according to claim 8, wherein the sodium silicate solution comprises SiO₂ accounting for 27.3 weight percentages (wt %), Na₂O accounting for 8.54 weight percentages (wt %), and a modulus is 3.3; and the sodium hydroxide solution is a liquid with a concentration of 10-20 M prepared by the sodium hydroxide solid particles with a purity≥96%.

11. The slag-based high-calcium AAM with the SF as the water reducer according to claim 8, wherein the slag is a precursor material for preparing the slag-based high-calcium AAM, and a mass percentage of each oxide in a chemical composition of the slag is as follows: 40.43% of CaO, 30.46% of SiO₂, 15.81% of Al₂O₃, 9.42% of MgO, 0.281% of Fe₂O₃, 0.423% of K₂O, 0.673% of TiO₂, 0.52% of MnO, 0.499% of Na₂O, 1.16% of S, 0.0549% of SrO, 0.0467% of Cl, 0.0391% of ZrO₂, 0.0389% of BaO, 0.017% of P₂O₅, 0.0084% of V₂O₅, 0.0083% of Y₂O₃, 0.0069% of CeO₂, and 0.0012% of CuO.
